(19) United States
(12) Patent Application Publication
(10) Pub. No.: US 2008/0060468 A1
(43) Pub. Date: Mar. 13, 2008

(54) HYBRID STEERING WHEEL AND METHOD OF FABRICATING SAME

(76) Inventors: Saverio Paonessa, Belleriver (CA); Cemal Sermet, Windsor (CA); William Jack Altenhof, Lakeshore (CA)

Correspondence Address: DYKEMA GOSSETT PLLC, 39577 WOODWARD AVENUE, SUITE 300, BLOOMFIELD HILLS, MI, 48304-5086, US

(21) Appl. No.: 11/836,336

(22) Filed: Aug. 9, 2007

Related U.S. Application Data
(60) Provisional application No. 60/825,337, filed on Sep. 12, 2006.

(51) Int. Cl. B62D 1/04; B21D 53/26

(52) U.S. Cl. 74/552; 264/241; 29/894.1

(57) ABSTRACT

An improved method for fabricating a hybrid steering wheel is provided that may integrate the overmolding of a polymeric layer with the formation of the rim to simplify the manufacturing process. The improved method for fabricating the hybrid steering wheel includes: forming a metallic skeleton which includes a hub and a plurality of fixed spokes extending from the hub; injection molding a first polymeric material to form a core, wherein the core arcuately connects the ends of the spokes; and injection molding a second polymeric material to form a skin over the core, wherein the core and skin form a rim of said steering wheel.

### RELATED APPLICATIONS

This application claims the benefit of U.S. Provisional Patent Application No. 60/825,337 filed Sep. 12, 2006, hereby incorporated by reference in its entirety.

### TECHNICAL FIELD

This invention relates to a method of fabricating a hybrid steering wheel, including a method of fabricating a hybrid steering wheel that includes the steps of forming a metallic skeleton with a hub and a plurality of fixed spokes extending from the hub, injection molding a first polymeric material to form a core that arcuately connects the ends of the spokes, and injection molding a second polymeric material to form a skin over the core.

### BACKGROUND

Most automotive vehicles provide a steering wheel that permits an operator to maintain directional control of the vehicle. Conventional steering wheels include a full cast or welded metal skeleton, including a hub, spokes, and a rim. The hub is mechanically fastened to the steering column, permitting a torsional load transfer from the steering wheel to the steering column. Connected with the hub are a plurality of radially extending spokes. A circular rim extends around the hub and connects the ends of the spokes. The metal skeleton is typically overmolded with a polymeric material, such as polyurethane, polyvinyl chloride, or polypropylene, for the comfort of the driver and also to improve the aesthetic appearance of the steering wheel. An air bag is typically provided adjacent the steering wheel hub.

The manufacturing of a full metal skeleton may be complex and can generate a significant amount of scrap in the diecast process due to the requirement that the metal flow fronts converge and form a full circular ring. Increased scrap costs can increase the manufacturing cost of the steering wheel. Furthermore, the manufacturing of a full metal skeleton may enable fewer steering wheels to be produced in connection with a single piece of equipment due to the large size of a full metal skeleton. Finally, a full metal skeleton may be relatively heavy, which can negatively affect fuel economy.

### SUMMARY

An embodiment of the invention provides a method of fabricating a steering wheel. A method of fabricating a steering wheel may comprise the following steps: forming a skeleton which includes a hub and a plurality of fixed spokes extending from the hub; injection molding a first polymeric material to form a core, wherein the core arcuately connects the ends of the spokes; and injection molding a second polymeric material to form a skin over the core, wherein the core and skin form a rim of the steering wheel.

Features and advantages of this invention will become apparent to one skilled in the art from the following detailed description and the accompanying drawings illustrating features of this invention by way of example.

### BRIEF DESCRIPTION OF THE DRAWINGS

FIG. 1 is a top plan view of a prior art skeleton of an automotive vehicle steering wheel.

FIG. 1A is a view taken along lines 1A-1A of FIG. 1.

FIG. 2 is a top plan view of a steering wheel fabricated in accordance with an embodiment of the present invention.

FIG. 2A is an enlarged view of a tee of a steering wheel fabricated in accordance with an embodiment of the present invention.

FIG. 2B is a perspective view of the end of a fixed spoke of a steering wheel fabricated in accordance with an embodiment of the present invention.

FIG. 3 is a flow chart illustrating the method of fabricating a steering wheel in accordance with an embodiment of the present invention.

FIG. 4 is a cross-sectional view of a segment of a polymeric rim of a steering wheel fabricated in accordance with an embodiment of the present invention.

FIG. 5 is a flow chart illustrating the method of fabricating a steering wheel in accordance with other embodiments of the present invention.

FIG. 6 is a cross-sectional view of a segment of a polymeric rim of a steering wheel fabricated in accordance with another embodiment of the present invention.

FIGS. 7A-7B are top plan views of a steering wheel fabricated in accordance with an embodiment of the present invention.

FIG. 7C is a cross sectional view of a cooling fixture for use in connection with fabricating a steering wheel in accordance with an embodiment of the present invention.

FIG. 8 is a cross-sectional view of a segment of a polymeric rim of a steering wheel fabricated in accordance with another embodiment of the present invention.

FIG. 9 is cross-sectional view of a mold used in fabricating a steering wheel in accordance with an embodiment of the present invention.

FIG. 10A is a flow chart illustrating the method of fabricating a steering wheel in accordance with another embodiment of the present invention.

FIG. 10B is a cross-sectional view of a segment of a polymeric rim of a steering wheel fabricated in accordance with another embodiment of the present invention.

FIG. 11A is a flow chart illustrating the method of fabricating a steering wheel in accordance with another embodiment of the present invention.

FIG. 11B is a cross-sectional view of a segment of a polymeric rim of a steering wheel fabricated in accordance with another embodiment of the present invention.

### DETAILED DESCRIPTION

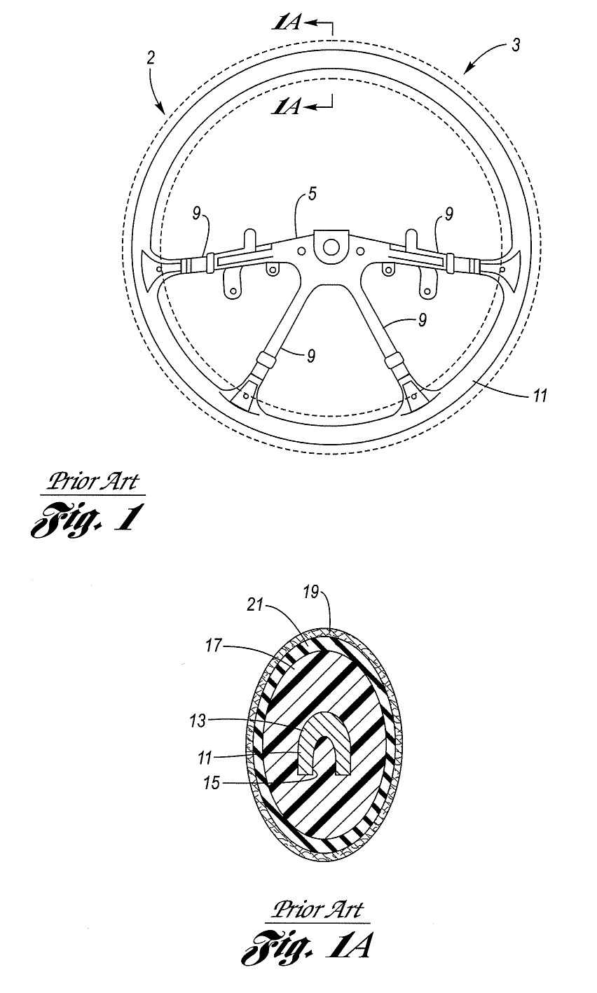

Referring now to the drawings wherein like reference numerals are used to identify identical or similar components in the various views, FIG. 1 illustrates a prior art steering wheel 2. For clarity of illustration, steering wheel 2 is shown minus its back cover, and the horn mechanism and air bag assembly have been removed. Steering wheel 2 includes skeleton 3, which is made of cast steel or magnesium or other suitable metallic material. Skeleton 3 has a hub 5, spokes 9, and rim 11. Hub 5 is provided for connection with the steering column (not shown) of the vehicle. Spokes 9 are provided to radially extend from hub 5 to support rim 11. Spokes 9 are typically welded to or integrally joined with rim 11. Rim 11 is provided to arcuately connect the ends of spokes 9 in a circular form. Referring now to FIG. 1A, rim 11 is a generally arc-like structure having an outer parabolic or elliptical-like surface 13 and inner parabolic or elliptical-like surface 15. Steering wheel 2 is typically placed within a molding machine where a polymeric core material 17 encapsulates the skeleton. Core material 17 may be the outer surface which is exposed to the vehicle operator in an exemplary embodiment. In other prior art wheels, core material 17 may be covered with a second polymeric material or may be wrapped or covered by a leather cover 19 having an optional foam backing 21.

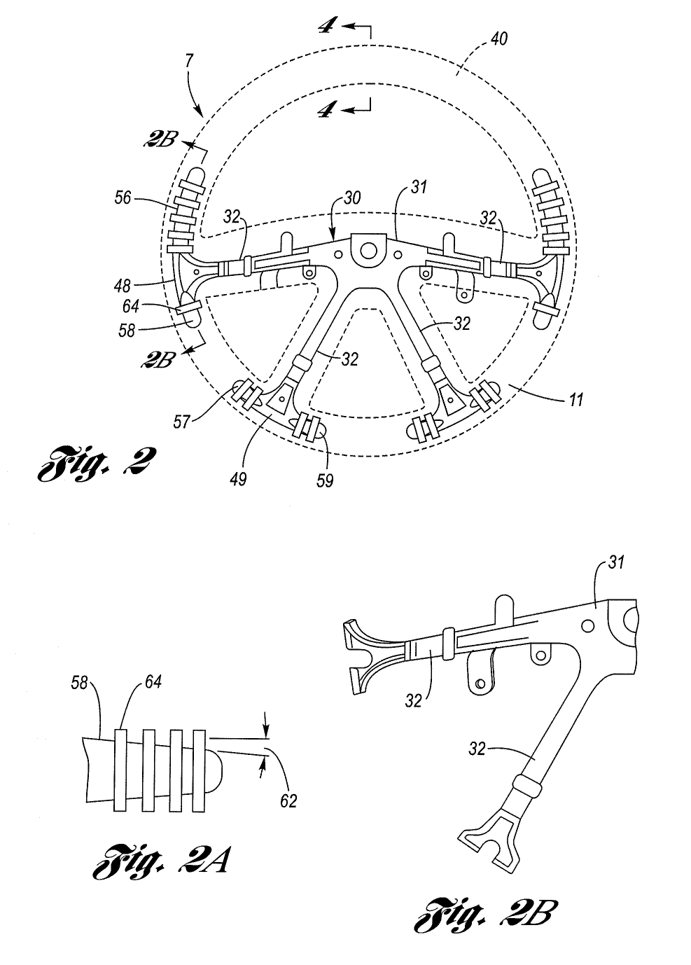

Referring now to FIG. 2, a hybrid steering wheel 7 produced in accordance with an embodiment of the present invention is illustrated. Again for clarity of illustration, steering wheel 7 is shown minus its back cover, and the horn mechanism and air bag assembly have been removed. Steering wheel 7 comprises partial skeleton 30 and polymeric rim 40. Partial skeleton 30 may be formed by casting, stamping, or weldment. Partial skeleton 30 may comprise cast steel, rolled or form steel, high strength steel or advanced high strength steel, cast aluminum or magnesium alloy, or other metallic material that has sufficient ductility for deflection and energy absorption during impact of the motor vehicle and fatigue, static, and noise and vibration harshness performance. Partial skeleton 30 may comprise hub 31 and fixed spokes 32. Hub 31 is provided for connection with the steering column (not shown) of the vehicle. Spokes 32 are provided to radially extend from hub 31 to support a polymeric rim 40.

Each of spokes 32 may be flared at an outer end. Referring now to FIG. 2, in an embodiment, the flared outer end of each of the fixed spokes 32 may include a tee 48, 49 to provide structural support during impact as the rim-to-spoke interface is potentially a high stress region. Tees 48, 49 may also provide a mechanical lock between polymeric rim 40 and spokes 32 at least in part due to the wedge shape of tees 48, 49. Tees 48, 49 may extend on both sides of spoke 32. Tee 48 may have a first wing 56 extending on a first side of spoke 32 and a second wing 58 extending on a second side of spoke 32. In an embodiment, first wing 56 may extend at least twice the length of second wing 58. Such as illustrated, the lengths of the wings associated with tee 48 need not have the same lengths or relationships as those of a second tee 49. Tee 49 may have a first wing 57 extending on a first side of spoke 32 and a second wing 59 extending on a second side of spoke 32. In an embodiment, first wing 57 and second wing 59 may extend approximately the same length. In an exemplary embodiment, tees 48, 49 may include tapered portions such as shown in FIG. 2A. The degree of tapering 62 may be between approximately 0 and 40 degrees. Although this degree of tapering is mentioned in detail, it is understood by those of ordinary skill in the art that various other degrees of tapering may be utilized and remain within the spirit and scope of the invention. If desired, both first wing 56 and second wing 58 may be tapered to help distribute load during impact at the ring-to-spoke interface. If desired, both first wing 57 and second wing 59 may be similarly tapered to help distribute load during impact at the ring-to-spoke interface. The length, width, and degree of tapering or curvature of tees 48, 49 may vary and remain within the spirit and scope of the invention, as recognized by those of ordinary skill in the art. For example, the length of the wings of the tees at the end of spoke 32 may be shorter as illustrated in FIG. 2B.

Referring again to FIGS. 2 and 2A, in another embodiment, tees 48, 49 may include at least one radial rib 64 for retaining polymeric rim 40 on the plurality of spokes 32. A plurality of radial ribs 64 may be provided and configured (e.g., positioned and spaced) to increase friction and act as a mechanical lock between the wings 56 or 58 or 57 or 59 and polymeric rim 40 during loading of the steering wheel. In one embodiment, first wing 56 may include one, two, three, or four radial ribs 64. In a similar manner, second wing 58 may include one, two, three, or four radial ribs 64. In another embodiment, first and second wings 57, 59 of second tee 49 may include one, two, three, or four radial ribs 64. Although these number of radial ribs are mentioned in detail, it is understood by those of ordinary skill in the art that fewer or more radial ribs may be included on tees 48, 49 and remain within the spirit and scope of the invention.

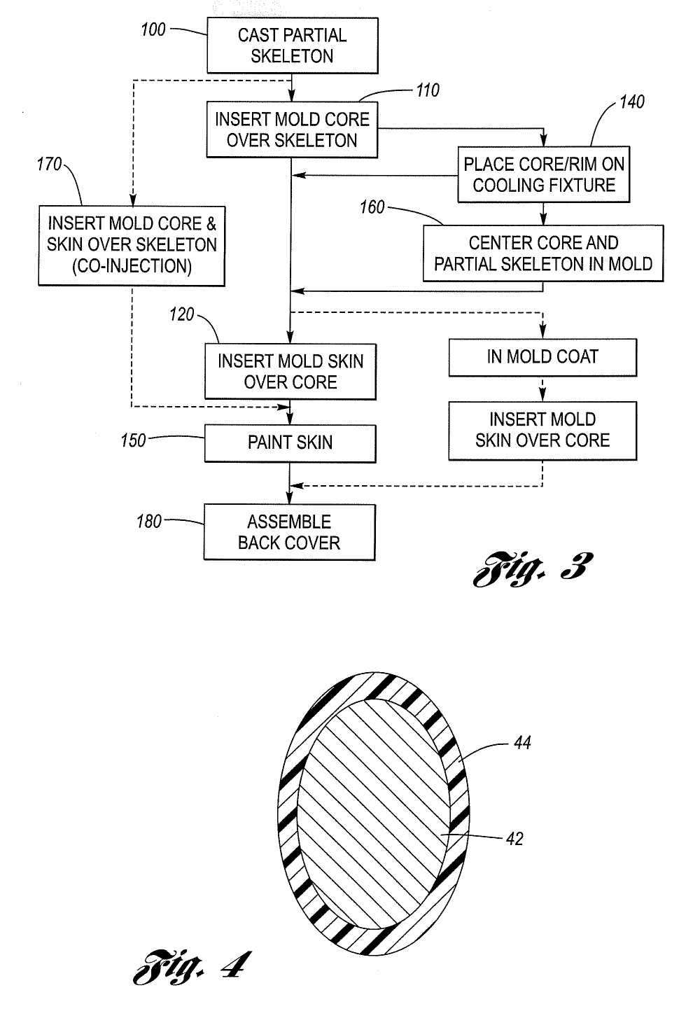

Referring now to FIG. 3, a method of fabricating a hybrid steering wheel in accordance with an embodiment of the present invention may include a first step 100 of forming a metallic partial skeleton 30 which includes hub 31 and a plurality of fixed spokes 32 extending from hub 31. In accordance with an embodiment of the present invention, partial skeleton 30 may be placed into an insert mold (not shown). The inventive method may further include a step 110 of injection molding a first polymeric material into the insert mold to form a core 42 for a polymeric rim 40. An example of a core 42 may be generally viewed in FIG. 4, which is a view taken along lines 4-4 of FIG. 2. Core 42 may arcuately connect ends of the spokes 32. Hybrid steering wheel 7 may be fabricated in accordance with any of the methods described herein. However, it should be understood by those of ordinary skill in the art that hybrid steering wheel 7 may also be fabricated in accordance with method other than those described herein, such that the described methods are not an essential part of the claimed hybrid steering wheel.

The diameter of a cross-section of a segment of core 42, as shown in FIG. 4, may be generally equal around the entire polymeric rim 40. However, in an exemplary embodiment, the diameter of a cross-section of a segment of core 42 may be smaller at one or more points along the core 42. For example, for some applications it may be advantageous for the diameter of a cross-section of a segment of the core 42 to be smaller at a segment (e.g., generally about 180° from an injection point of a second material) to form a covering for the core 42. The reduced diameter of core 42 may enable the flow fronts of the second material forming the covering to more effectively fuse together by increasing the amount of material at the reduced diameter segment. This reduced diameter section may typically be in the 12 o'clock or between the 10 o'clock and 2 o'clock positions of steering wheel 7. Although these locations for reduced diameter sections are mentioned in detail, it is understood by those of ordinary skill in the art that various other locations for the reduced diameter sections may be utilized and remain within the spirit and scope of the invention.

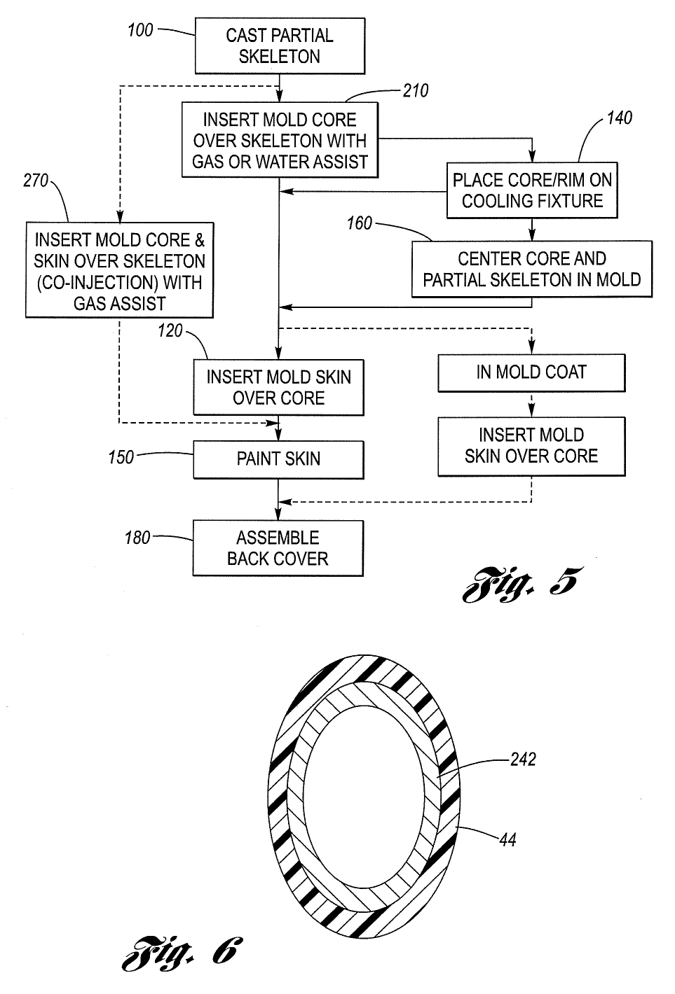

In a first embodiment, the step 110 of injection molding a first polymeric material to form a core may comprise an injection molding process. Accordingly, the resulting core 42 may be solid, for example, as shown in FIG. 4. In a second embodiment (for example, as generally illustrated in FIG. 5), the step 210 of injection molding a first polymeric material may comprise a gas-assist or water-assist injection molding process. Accordingly, the resulting core 242 may be at least partially hollow, for example, as shown in FIG. 6. Referring now to FIG. 2, rim 40 extends circumferentially around hub 30. Portions of rim 40 may comprise a hollow core 242, while other portions of rim 40 may comprise a solid core 42. In an embodiment, a majority of rim 40 extending circumferentially around hub 30 may comprise a hollow core 242. In another embodiment, after step 110 of injection molding a first polymeric material, a foaming agent may be added to expand the core 42 from the inside out creating a solid skin and a porous center. During step 110 or 210, the number and configuration of gates (and gas or water injection points for step 210) will depend on the material selection as recognized by those of ordinary skill in the art.

The first polymeric material may comprise acrylonitrile butadiene styrene (ABS), nylon, or polypropylene in exemplary embodiments. In an embodiment, a modified polypropylene blend with rubber that may aid in preventing crack propogation during impact may be used. Talc may also be added to the first polymeric material to increase static strength. Although these materials are mentioned in detail, it is understood by those of ordinary skill in the art that various other materials may be used for injection molding of the core and remain within the spirit and scope of the invention. The first polymeric material may comprise a material that is mechanically capable of meeting performance requirements under impact, fatigue, static, and/or vibration harshness loading conditions. At least one injection point for the first polymeric material may be proximate one of the plurality of spokes 32 to ensure that the core 42 or 242 is securely coupled to the metallic partial skeleton 30. In an embodiment, an injection point or gate may be located at 3 o'clock or 9 o'clock of steering wheel 7 with the gas or water pin proximate the gate. Although these injection points or gate locations are mentioned in detail, it is understood by those of ordinary skill in the art that various other injection points or gate locations may be utilized and remain within the spirit and scope of the invention.

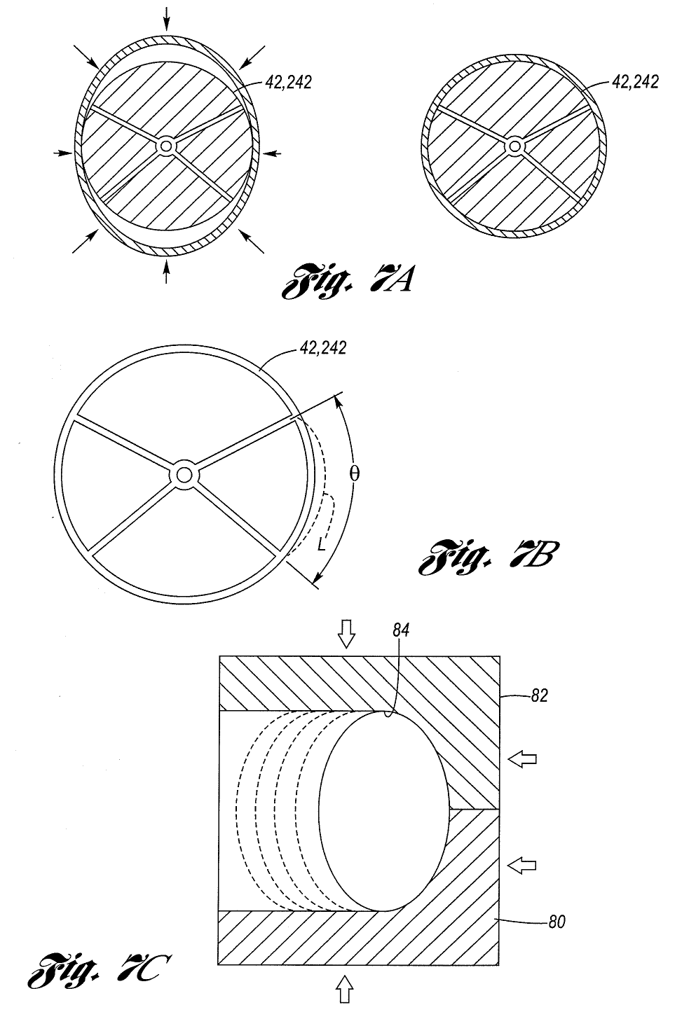

The core 42 or 242 may be molded into a non-circular shape as shown in FIG. 7A. In embodiments, the core 42 or 242 may comprise an oval shape, an elliptical shape, a semi-elliptical shape, or a saddle shape. Although these shapes are mentioned in detail, it is understood by those of ordinary skill in the art that various other shapes may be utilized and remain within the spirit and scope of the invention. The non-circular shape of the core 42 or 242 may allow the core to compensate for shrinkage and distortion due to the large amount of unsupported material in core 42 or 242, thereby resulting in a circular shape of core 42 or 242 during the cooling or curing process. In order to determine the appropriate size and shape of the non-circular core 42 or 242, a formula may be used. In an embodiment, a length of the arc of the core 42 or 242 between two of the plurality of fixed spokes may be generally equal to the average diameter of the cross-section of a segment of the core times π times the angle between the two of the plurality of fixed spokes divided by 360 times the inverse of 1 minus the percentage of shrink rate of the first polymeric material. In other words, the length of the arc of the core between each spoke may be calculated as follows to determine the molded core size that will allow the core to shrink to a circular shape as it cools as shown in FIG. 7B.
D=Average diameter of wheel ring (mm)
θ=angle between two spokes (degrees)
α—shrink rate of material (%)
L=length of ring between 2 spokes adjusted for shrink (mm)

L=πD(θ/360)(1/(1−α))

The inventive method may further include the step 140 of placing the core 42 or 242 on a cooling fixture for shrinking the core during the cooling process to form the circular shape of the core. Referring now to FIG. 7C, the cooling fixture may comprise a lower half 80 and an upper half 82. In another exemplary embodiment, the cooling fixture may comprise one piece that is collapsible in certain areas to allow the part to be removed. The cooling fixture may be provided to hold the wheel at the spoke areas where shrink is minimal due to partial skeleton 30. Referring to FIG. 7C, the cooling fixture may have an outer perimeter boundary 84 which is that of an inner diameter of a torus. The cooling fixture may be cleared along the outside perimeter 84, allowing the warm core to fit in a fixture. The remainder of the fixture surface may be used to control the x, y, and z tolerance during cooling, thereby forcing the core to cool to a proper shape and position. In an embodiment, the curing process may take approximately 2 to 20 minutes depending upon the particular geometry of the steering wheel cross-section and the material of the polymeric core, as will be recognized by those of ordinary skill in the art.

In accordance with the present invention, partial skeleton 30 and the core 42 or 242 of the polymeric rim 40 may be placed into an insert mold (not shown). The inventive method may further include step 120 of injection molding a second polymeric material to form a skin 44 over the core 42 or 242. Skin 44 may take the basic shape of core 42 or 242 and may not require the use of a cooling fixture. The core 42 or 242 and the skin 44 together may form a polymeric rim 40 of steering wheel 7 that arcuately connects spokes 32.

The second polymeric material for step 120 of forming a skin over the core may comprise polyurethane, a thermoplastic elastomer, or polyvinylchloride in an exemplary embodiment. Other soft decorative materials may also be used. Although these materials are mentioned in detail, it is understood by those of ordinary skill in the art that various other materials may be used for injection molding of the skin and remain within the spirit and scope of the invention. In an embodiment, in the step 120 of injection molding a second polymeric material to form a skin 44 over the core 42 or 242, the skin 44 may completely cover an outer surface of the core 42 or 242, for example as shown generally in FIGS. 4 and 6. In another embodiment, the skin may only partially cover an outer surface of the core, for example as shown generally in FIG. 8. Although an example of a core that may be formed by a gas-assist or water-assist injection molding step 210 is shown in FIG. 8, it is understood by those of ordinary skill in the art that the skin may also only partially cover an outer surface of a core formed by a traditional injection molding step 110. During step 120, the number and configuration of gates will depend on the material selection, as recognized by those of ordinary skill in the art. In an embodiment, an injection point or gate may be located at 6 o'clock of steering wheel 7. Although this injection point or gate location is mentioned in detail, it is understood by those of ordinary skill in the art that various other locations may be utilized and remain within the spirit and scope of the invention. The skin 44 may be bonded to the core 42 if the first and second polymeric materials have a natural bond. If the first and second polymeric materials do not have a natural bond, a heat-activated adhesive may be applied to core 42 prior to step 120. The heat produced during step 120 may activate the adhesive to form a bond between core 42 and skin 44.

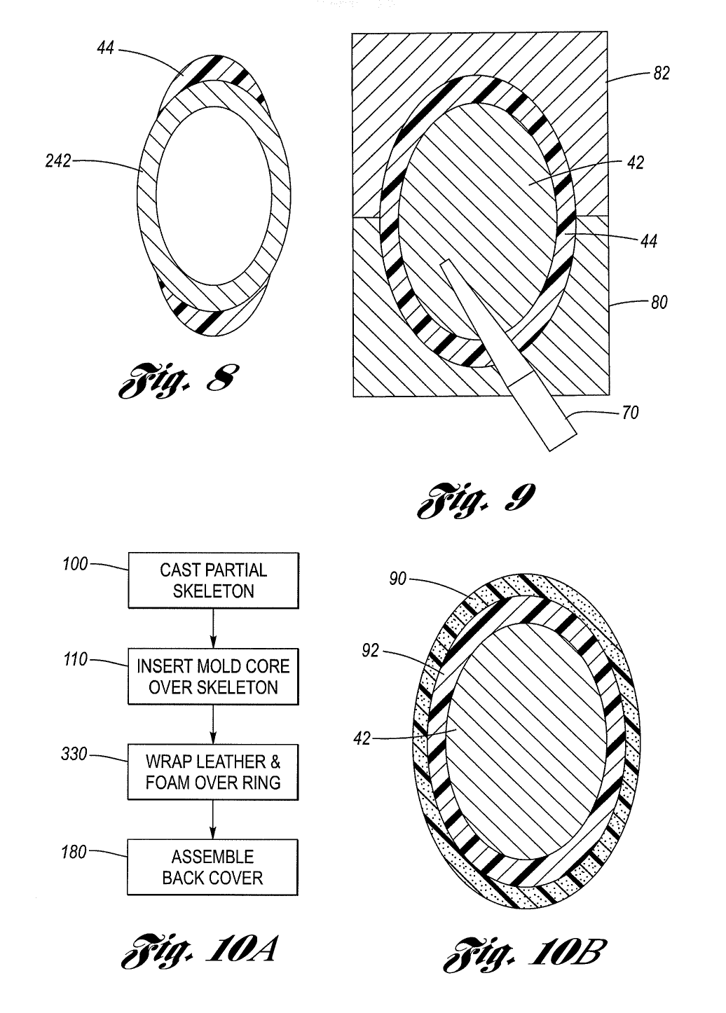

In an embodiment, the method of the present invention may include additional steps before the step 120 of injection molding a second polymeric material to form a skin over the core. In particular, step 160 of centering the core and partial skeleton 30 in the insert mold cavity (not shown) may be performed. Step 160 may be provided to ensure control of the rim dimensions in the plane of the rim (e.g., x and y axes directions) and in the axis of the column (e.g., z axis direction). In order to perform step 160 of centering the core and partial skeleton 30 in an insert mold cavity, angled rim pins 70 may be used to engage and hold the core and partial skeleton 30 in the insert mold cavity, as generally shown in FIG. 9. In order to perform step 160, when molding the core during step 110, a set of conventional tapering rim pins may be used in one or two positions, typically between the 8 o'clock and 2 o'clock position of the wheel, to create a set of holes in the core. Then during step 120 of injection molding a second polymeric material to form a skin over the core, a second set of angled rim pins 70 may be used to engage the holes during formation of the skin to ensure that the core and partial skeleton 30 are centered in the insert mold cavity. Usually, distortion in the z-axis direction may be addressed at this point of the molding operation. In an embodiment, the angle of the pins 70 may be approximately 45 degrees to the z axis direction and pointing radially in towards the center of the wheel at approximately 2 o'clock and 10 o'clock on the core 42 or 242. Although these angles and configuration are mentioned in detail, it is understood by those or ordinary skill in the art that various other angles and configurations may be used and remain within the spirit and scope of the invention. Pins 70 may be provided to force the core 42 or 242 into position by generating x, y, and z forces that center the core in the second insert mold.

In an embodiment of a method in accordance with the present invention, steps 110 and 120 may be combined into a single step, such that the second polymeric material may be co-injected with the first polymeric material, such as in step 170 of FIG. 3. In this embodiment, partial skeleton 30 may be placed into a mold (not shown), and a first polymeric material is shot into the mold and then a second polymeric material is shot into the mold. In another embodiment of a method in accordance with the present invention, steps 210 and 120 may be combined into a single step, such that the second polymeric material may be co-injected with the first polymeric material, such as in step 270 of FIG. 5. Again, at least one injection point for the first and second polymeric materials may be proximate one of the plurality of spokes 32 to ensure that the core is securely coupled to the metallic partial skeleton 30.

The method may further include an optional step 150 of painting the skin, depending upon the nature of the second polymeric material used to form the skin. The inventive method may further include a step 180 of assembling a back over of the steering wheel 7.

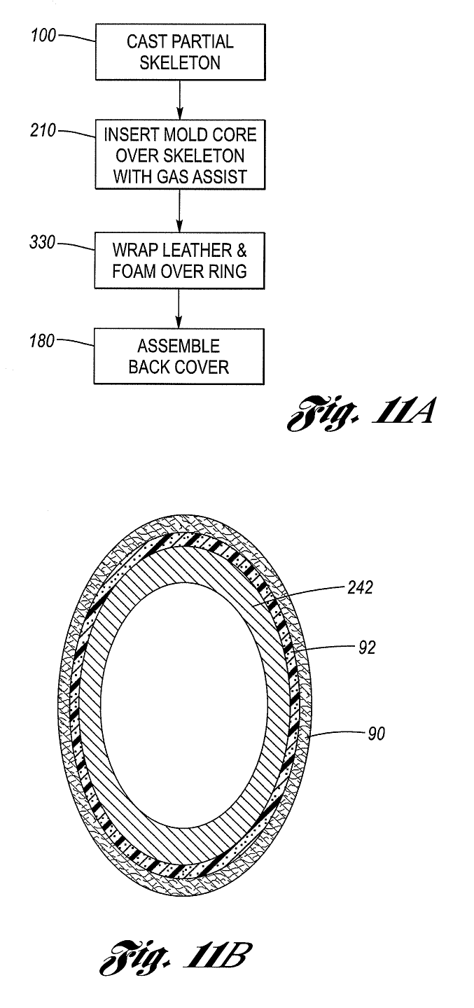

In another embodiment shown in FIGS. 10A-10B, the method may include step 100 of forming a metallic partial skeleton 30 which includes hub 31 and a plurality of fixed spokes 32 extending from hub 31; step 110 of injection molding a first polymeric material into the insert mold to form a core for a polymeric rim; and step 330 of wrapping a cover over the core. The cover may comprise foam or leather (e.g., natural leather or a synthetic lather material) or a combination thereof. Although these materials are mentioned in detail, it is understood by those of ordinary skill in the art that various other materials may be used for the cover and remain within the spirit and scope of the invention. In an embodiment, the core 42 may be wrapped with leather covering 90 as, for example, shown in FIG. 10B. Leather covering 90 may have foam backing 92, as also shown in FIG. 10B for example. Step 110 of injection molding a first polymeric material to form a core may comprise a traditional injection molding process, resulting in a solid core as shown in FIG. 10B. In another embodiment generally shown in FIGS. 11A-11B, the step of injection molding a first polymeric material into the insert mold to form a core for a polymeric rim may comprise step 210 of a gas-assist or water-assist injection molding process, resulting in at least partially hollow core, for example, as shown in FIG. 11B.

A method of fabricating a hybrid steering wheel in accordance with embodiments of the present invention may be advantageous as compared to existing methods of fabricating steering wheels. The following is a generally and non-limiting list of potential benefits with respect to embodiments of the invention. First, the inventive method may eliminate the metal ring of the skeleton, and the hybrid steering wheel skeleton may have no flow fronts that need to converge. Accordingly, the amount of scrap may be decreased, along with the cost of manufacturing the hybrid steering wheel skeleton. Second, the inventive method may integrate the overmolding with the formation of the ring, thereby simplifying the manufacturing process. Third, the smaller size of the partial skeleton may allow additional wheels to be produced on the same amount of equipment, thereby reducing the manufacturing cost per wheel. Fourth, the partial metal skeleton may reduce the weight of the vehicle, thereby improving fuel economy.

While the invention has been shown and described with reference to one or more particular embodiments thereof, it will be understood by those of skill in the art that various changes and modifications can be made without departing from the spirit and scope of the invention.

We claim:

1. A method of fabricating a steering wheel, comprising:
forming a metallic skeleton which includes a hub and a plurality of fixed spokes extending from said hub;
injection molding a first polymeric material to form a core, wherein said core arcuately connects ends of said spokes; and
injection molding a second polymeric material to form a skin over said core, wherein said core and skin form a rim of said steering wheel.

2. A method in accordance with claim 1, wherein said second polymeric material is co-injected with said first polymeric material.

3. A method in accordance with claim 1, wherein said core is solid.

4. A method in accordance with claim 1, wherein said core is at least partially hollow.

5. A method in accordance with claim 1, wherein said step of injection molding a first polymeric material comprises a gas-assist or water-assist injection molding process.

6. A method in accordance with claim 1, wherein an end of at least one of said plurality of fixed spokes is flared.

7. A method in accordance with claim 1, wherein an end of at least one of said plurality of fixed spokes forms a tee.

8. A method in accordance with claim 1, wherein at least one of said plurality of fixed spokes includes at least one radial rib.

9. A method in accordance with claim 1, wherein said skin partially covers an outer surface of said core.

10. A method in accordance with claim 1, wherein said core is molded into a non-circular shape.

11. A method in accordance with claim 1, further comprising placing said core on a cooling fixture for shrinking said core during a curing process.

12. A method in accordance with claim 1, wherein said first polymeric material comprises polypropylene, acrylonitrile butadiene styrene, or nylon.

13. A method in accordance with claim 1, wherein said second polymeric material comprises polyurethane, thermoplastic elastomer, or polyvinylchloride.

14. A method in accordance with claim 1, further comprising centering said core in a mold cavity for injection molding a second polymeric material to form said skin, wherein said step of centering said core includes using a pin to engage and hold said core in said mold cavity for injection molding a second polymeric material.

15. A method in accordance with claim 1, further comprising:
creating holes in said core with a first set of pins during the formation of said core; and
using a second set of pins to engage said holes during the formation of said skin, wherein said second set of pins positions said core in a mold cavity during formation of said skin.

16. A method in accordance with claim 1, where said skin is naturally bonded to said core during the molding of said skin to said core.

17. A method in accordance with claim 1, wherein an adhesive is disposed between said core and said skin.

18. A method in accordance with claim 1, wherein a diameter of a cross-section of said core is decreased at a point generally about 180 degrees from an injection point.

19. A method in accordance with claim 1, wherein an injection point for said first polymeric material and said second polymeric material is proximate one of said plurality of fixed spokes.

20. A method in accordance with claim 1, wherein a length of said rim between two of said plurality of fixed spokes is generally equal to the average diameter of the rim times π times the angle between said two of said plurality of fixed spokes divided by 360 times the inverse of 1 minus the percentage of shrink rate of said first polymeric material.

21. A method of fabricating a steering wheel, comprising:
forming a metallic skeleton which includes a hub and a plurality of fixed spokes extending from said hub;
injection molding a first polymeric material to form a core, wherein said core arcuately connects ends of said spokes; and
wrapping a cover over said core.

22. A method in accordance with claim 21, wherein said cover comprises foam, natural leather, or synthetic leather material.

23. A steering wheel for a motor vehicle, comprising:
a metal hub;
a first metal spoke connected with said hub and extending outwardly therefrom;
a first tee connected adjacent the outer end of said first spoke, said first tee having a first wing extending on a first side of said first spoke and a second wing extending on a second side of said first spoke;
a second metal spoke connected with said hub and extending outwardly therefrom;
a second tee connected adjacent the outer end of said second spoke, said second tee extending on both sides of said second spoke; and
a molded polymeric rim surrounding said hub and encapsulating said first and second tees.

24. A steering wheel in accordance with claim 23, wherein said first tee has at least one radial rib.

25. A steering wheel in accordance with claim 23, wherein said first tee is tapered at the ends of said first and second wings.

26. A steering wheel in accordance with claim 23, wherein a majority of said rim is hollow.

27. A steering wheel in accordance with claim 26, wherein said rim is formed by gas-assisted injection molding.

28. A steering wheel in accordance with claim 23, wherein said rim comprises poly acrylonitrile butadiene styrene (ABS), polypropylene, or nylon.
